(19) United States
(12) Patent Application Publication
(10) Pub. No.: US 2020/0003407 A1
(43) Pub. Date: Jan. 2, 2020

(54) AIR EXHAUSTING MECHANISM FOR MOBILE ILLUMINATING LIGHTHOUSE

(71) Applicant: ATLAS COPCO (WUXI) COMPRESSOR CO., LTD., Wuxi (CN)

(72) Inventors: Qiang LI, Wuxi (CN); Xia YU, Wuxi (CN); Dezhong LU, Wuxi (CN); Haiying CONG, Wuxi (CN)

(73) Assignee: ATLAS COPCO (WUXI) COMPRESSOR CO., LTD., Wuxi (CN)

(21) Appl. No.: 16/469,221

(22) PCT Filed: Dec. 21, 2017
(86) PCT No.: PCT/CN2017/117660

§ 371 Date: Jun. 13, 2019

(30) Foreign Application Priority Data
Dec. 22, 2016 (CN) 201621423806.2

(51) Int. Cl. F21V 29/67; F21L 13/00; F21V 29/502

(52) U.S. Cl. CPC F21V 29/677; F21W 2131/10; F21V 29/502; F21L 13/00

(57) ABSTRACT

An air exhausting mechanism for a mobile illuminating light tower includes a cooler, an air discharge hood, and a fan. The cooler and the air discharge hood are respectively disposed on two sides of a rear canopy panel. The cooler is mounted on a bottom plate, and is located on the inner side of the rear canopy panel. The air discharge hood is fixedly mounted on the outer side of the rear canopy panel. The cooler is provided with an air inlet and an air outlet. An air exhausting groove is formed in the rear canopy panel. The fan is disposed at the air inlet of the cooler. The air exhausting groove is opposite to the air outlet. The air discharge hood covers the air exhausting groove, and the bottom of the air discharge hood is open. The mobile illuminating light tower is safe and environmentally friendly.

### TECHNICAL FIELD

The present patent application relates to a mobile illuminating light tower, and more particularly, to an air exhausting mechanism for a mobile illuminating light tower.

### BACKGROUND

A mobile illuminating light tower is used for road illuminating, industrial-place illuminating, flood illuminating of building exteriors and for commercial illuminating and industrial illuminating outdoors.

The generator set of the mobile illuminating light tower is installed in the vehicle body. Heat will be generated when the generator set works, and the heat in the vehicle body needs to be discharged. At present, the method to provide an air exhausting groove on the canopy panel of the vehicle body to facilitate the ventilation of the interior of the vehicle body so as to discharge the heat is usually adopted. Several air exhausting grooves are usually respectively provided on the front canopy panel and the rear canopy panel for heat dissipation in order to enhance air flow inside the vehicle body, and in order to accelerate heat dissipation, forced convection is usually carried out by a fan to discharge the hot air from the air exhausting grooves on the rear canopy panel.

Since the hot air is directly discharged and the safety of the operator will also be affected, it is necessary to avoid the air exhausting area as much as possible during use.

### SUMMARY OF THE INVENTION

In order to solve the above problems, the present patent application provides an air exhausting mechanism for a mobile illumination light tower to achieve safe exhausting of the hot air in the vehicle body and ensure the safety of the operator.

To achieve the above objectives, the air exhausting mechanism for a mobile illuminating light tower of the present patent application comprises a cooler, an air discharge hood and a fan, the cooler and the air discharge hood being respectively disposed on two sides of a rear canopy panel of the mobile illuminating light tower, the cooler being mounted on a bottom plate of the mobile illuminating light tower and located on an inner side of the rear canopy panel, the air discharge hood being fixedly mounted on an outer side of the rear canopy panel; the cooler being provided with an air inlet and an air outlet, an air exhausting groove being formed in the rear canopy panel, the fan being disposed at the air inlet of the cooler, the position of the air exhausting groove being opposite to the air outlet; the air discharge hood covering the air exhausting groove, and a bottom of the air discharge hood being open.

Preferably, the cooler is fixed to the bottom plate by a mounting bracket.

Preferably, a silencing layer is laid on an inner wall of the air discharge hood.

Preferably, the silencing layer is composed of silencing cotton.

Preferably, an elastic spacer is disposed between the air discharge hood and the rear canopy panel.

The air exhausting mechanism for the mobile illuminating light tower of the present patent application changes an air exhausting direction to downward air exhausting via the air exhausting hood, thereby avoiding the safety impact of the direct air exhausting on the operator; discharges the hot air in the vehicle body of the mobile illuminating light tower outside the vehicle body after the hot air is cooled by the cooler, and a silencing layer is provided in the air exhausting hood to reduce the noise, so that the mobile illuminating light tower is more environmentally friendly and meets the requirements of hot air exhausting and noise level. By using the air exhausting mechanism for a mobile illuminating light tower of the present patent application, the mobile illuminating light tower has the advantages of being safe and environmentally friendly and the like.

### BRIEF DESCRIPTION OF THE DRAWINGS

The disclosure of the present patent application will become more apparent from the accompanying drawings. It is to be understood that the drawings are merely schematic and are not drawn to scale nor intended to limit the scope of the patent application, wherein:

FIG. 1 is a schematic view of a mobile illuminating light tower having the air exhausting mechanism for a mobile illuminating light tower of the present invention;

FIG. 2 is a schematic view of the mobile illumination light tower in another perspective corresponding to FIG. 1;

FIG. 3 is a schematic view of the front and rear canopy panels removed from the mobile illuminating light tower in FIG. 2; and

FIG. 4 is a schematic view of the air discharge hood.

### DETAILED DESCRIPTION OF EMBODIMENTS

Specific embodiments of the present invention will be described in detail below with reference to the accompanying drawings.

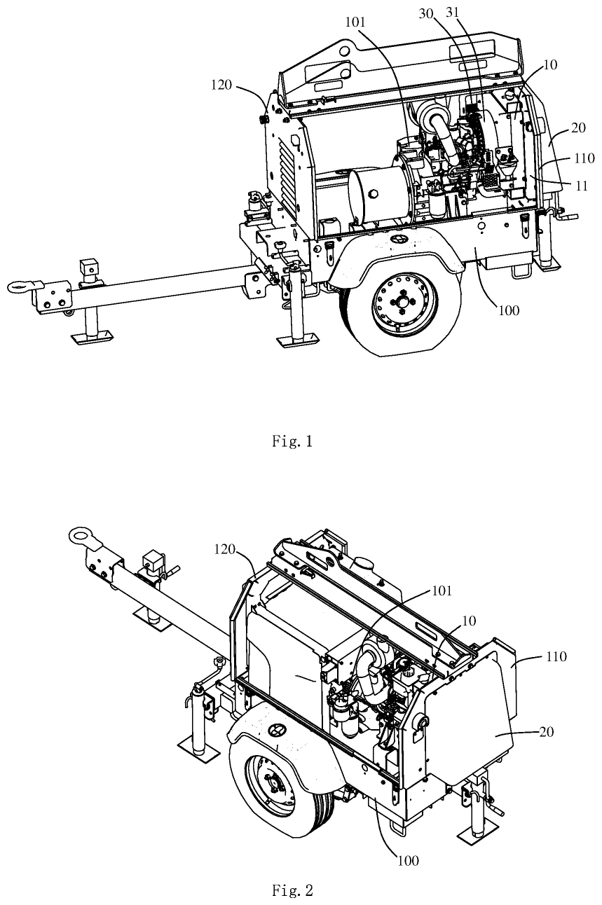

As shown in FIG. 1 to FIG. 4, an air exhausting mechanism for a mobile illuminating light tower of the present patent application comprises a cooler 10, an air discharge hood 20, and a fan 30. The cooler 10 and the air discharge hood 20 are respectively disposed on two sides of a rear canopy panel 110 of the mobile illuminating light tower. The cooler 10 is mounted on a bottom plate 100 of the mobile illuminating light tower and located on an inner side of the rear canopy panel 110. The air discharge hood 20 is fixedly mounted on an outer side of the rear canopy panel 110. The cooler 10 is preferably fixed to the bottom plate 100 by a mounting bracket 11. The mounting bracket 11 and the rear canopy panel 100 may be fixed together, or the mounting bracket 11 and the rear canopy panel 100 may be respectively fixed on the bottom plate 100.

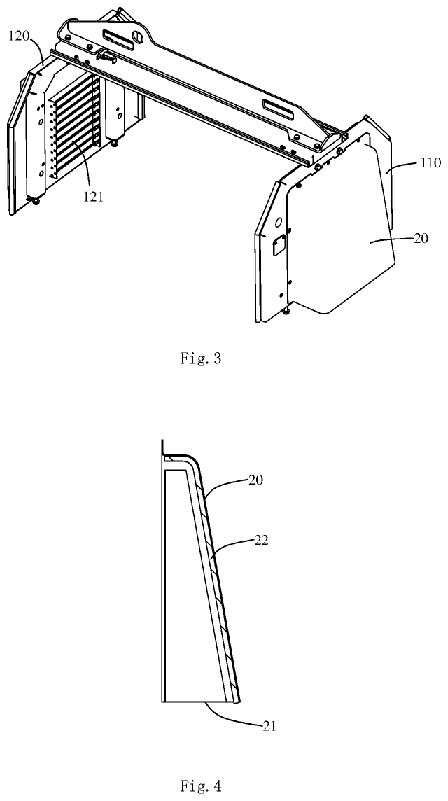

The cooler 10 has an air inlet and an air outlet (not shown). An air exhausting groove (not shown) is formed in the rear canopy panel 110. An air exhausting groove 121 formed in the front canopy panel 120 is shown in FIG. 3. The structure of the air exhausting groove formed in the rear canopy panel 110 is the same as that of the air exhausting groove 121 formed in the front canopy panel 120. The structure of the air exhausting groove can be that multiple air exhausting grooves are arranged up and down. The fan 30 is disposed at the air inlet of the cooler 10, and the position of the air exhausting groove is opposite to the air outlet, for discharging, via the air exhausting groove, air discharged from the air outlet outside a vehicle body of the mobile illuminating light tower. After the hot air in the vehicle body is cooled by the cooler 10, it exits from the air outlet and is discharged outside the vehicle body via the air exhausting groove. The fan 30 can accelerate the discharge of the hot air in the vehicle body. The hot air is discharged after being cooled by the cooler 10, thereby avoiding side effects on the surrounding environment. The fan 30 here may be a fan self-contained by an engine of a generator set 101, or the fan 30 may be separately provided to enhance air exhausting.

The air discharge hood 20 covers the air exhausting groove, and a bottom 21 of the air discharge hood 20 is open. The air discharge hood 20 can cause the air discharged from the air exhausting groove to be discharged from the bottom of the air discharge hood 20, so as to avoid air exhausting being directly facing the human body and ensure the safety of an operator. The air discharge hood 20 covers the air exhausting groove, which can further prevent dust and the like from entering the vehicle body through the air exhausting groove.

There is a corresponding noise level requirement when the mobile illuminating light tower is used. Since noise will be generated when air exhausting is directly facing the air discharge hood 20, a silencing layer 22 is laid on an inner wall of the air discharge hood 20 in order to reduce the noise. The silencing layer 22 is composed of silencing cotton, and the silencing cotton is attached to the inner wall of the air discharge hood 20.

An elastic spacer (not shown) is disposed between the air discharge hood 20 and the rear canopy panel 110, which can reduce vibration of the air discharge hood 20 due to air exhausting and thus prevent the air discharge hood from being damaged because of the vibration while reducing the noise.

As described above, exemplary embodiments of the present patent application have been described in detail with reference to the accompanying drawings. It should be understood that it is not intended to limit the scope of the present patent application by these specific details. Equivalent or similar changes may be made to the structures and features of the exemplary embodiments without departing from the spirit and scope of the present invention, and these changes will also fall within the scope of the appended claims of the present patent application.

1.-5. (canceled)

6. An air exhausting mechanism for a mobile illuminating light tower, comprising a cooler, an air discharge hood and a fan,
the cooler and the air discharge hood being respectively provided on two sides of a rear canopy panel of the mobile illuminating light tower, the cooler being mounted on a bottom plate of the mobile illuminating light tower and located on an inner side of the rear canopy panel, the air discharge hood being fixedly mounted on an outer side of the rear canopy panel;
the cooler being provided with an air inlet and an air outlet, an air exhausting groove being formed in the rear canopy panel, the fan being provided at the air inlet of the cooler, the position of the air exhausting groove being opposite to the air outlet;
the air discharge hood covering the air exhausting groove, and a bottom of the air discharge hood being open.

7. The air exhausting mechanism for a mobile illuminating light tower according to claim 6, wherein the cooler is fixed to the bottom plate by a mounting bracket.

8. The air exhausting mechanism for a mobile illuminating light tower according to claim 6, wherein a silencing layer is laid on an inner wall of the air discharge hood.

9. The air exhausting mechanism for a mobile illuminating light tower according to claim 8, wherein the silencing layer is composed of silencing cotton.

10. The air exhausting mechanism for a mobile illuminating light tower according to claim 6, wherein an elastic spacer is disposed between the air discharge hood and the rear canopy panel.
